(19) United States
(12) Patent Application Publication
(10) Pub. No.: US 2007/0075842 A1
(43) Pub. Date: Apr. 5, 2007

(54) Pill-Mate / Event-Reminder

(76) Inventors: Wanda Zhao Russell, Fort WOrth, TX (US); Zhaohui Jiang, Hefei (CN); Huanqing Feng, Hefei (CN)

Correspondence Address: Dr. Wanda Zhao Russell, 300 Covered Bridge CT, Fort Worth, TX, 76108-9636, US

(21) Appl. No.: 11/161,877

(22) Filed: Aug. 19, 2005

(51) Int. Cl. G08B 1/00

(52) U.S. Cl. 340/309.16

(57) ABSTRACT

A very first new pill-mate/event-reminder uses electronic alarms to remind people at the pre-set time to take medicines or attend events. It has 5 settings: 4 times/day (every 4 hours); 3 times/day (every 6 hours); 2 times/day (every 12 hours); 1 time/day (every 24 hours); and 1 time/week. This device uses switches for the different choices, and uses buzzer and LEDs to indicating the status of the timing and alarms. This device can have ribbons to connect all pill bottles for the same choice together so users can hook unlimited pill bottles together for the same choice. For traveling users can use cascade-able medicine compartments for more convenience.

The present invention relates to a pill-mate/event-reminder.

Everybody gets sick sometimes and needs to take medicines. Dietary supplements are used very common as well. Taking medicines or dietary supplements requires arranging time, and usually it is a bothersome matter when people need to take more than one medicine and more than once a day. Especially for seniors, forgetting taking medicines at the scheduled time would worsen their health conditions.

Our Pill-Mate/Event-Reminder addresses this issue. It is the very first one developed for this application. The Pill-Mate/Event-Reminder has different choices of different timing for different medicines, and is still simple to use. The device comprises almost all the possible choices (how many times per day or per week, and what is the interval of them), and it can embrace unlimited kinds of medicine bottles. When the pre-set time is up the alarm goes off to remind the user to take the relevant medicines. After the patient resets the switch the counting resumes for next time.

The functions of this device make it conventional and convenient for everybody to use.

### BRIEF DESCRIPTION OF THE DRAWINGS

FIG. 1 is a general review of the Pill-Mate/Event-Reminder with pill compartment attached.

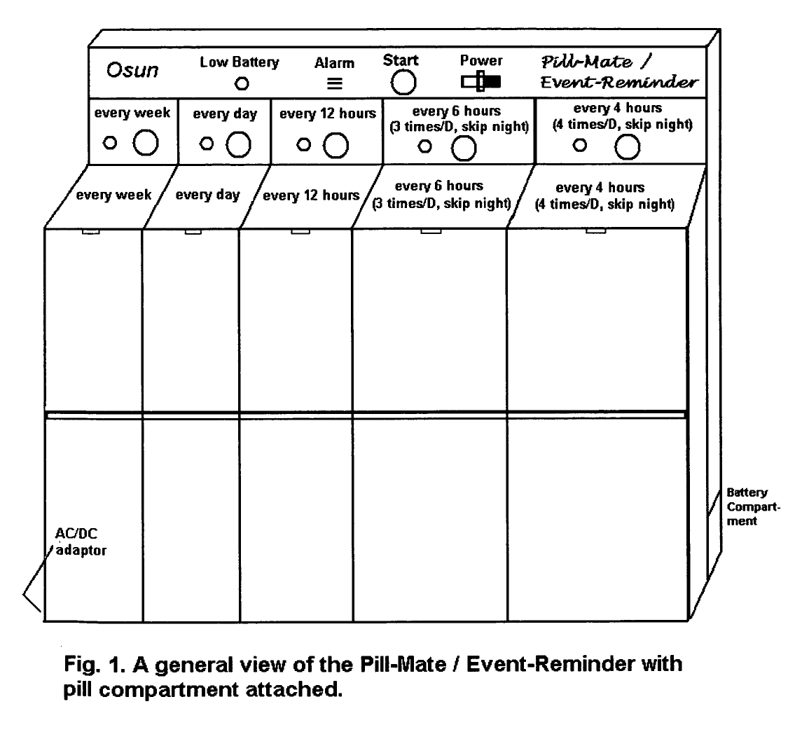

FIG. 2 is the control unit itself and a series of pill bottles attached to the control unit. This figure shows the usage of the device.

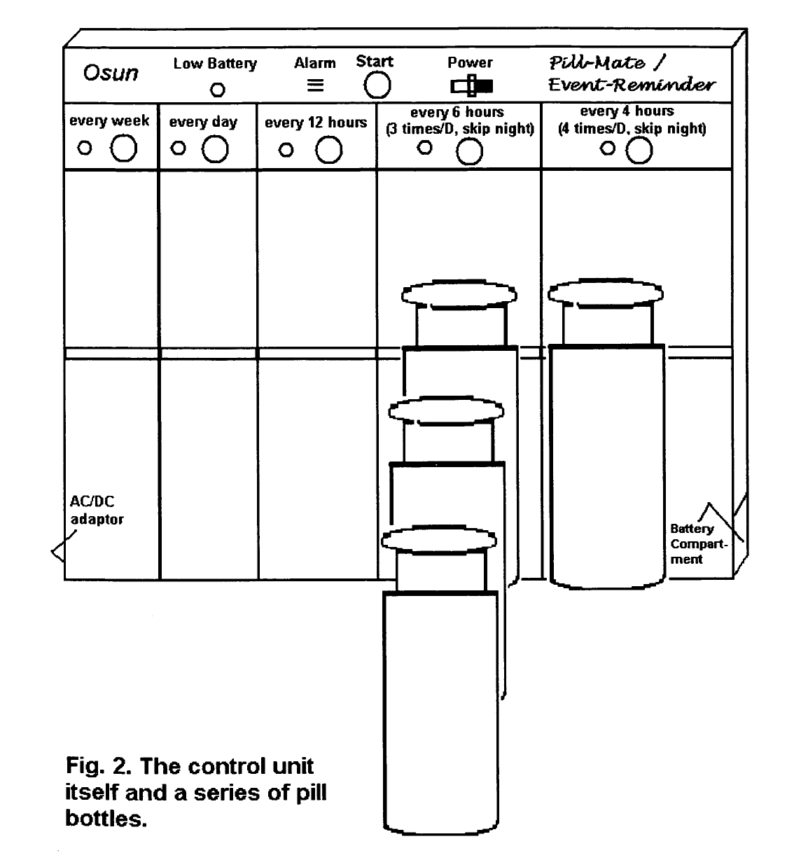

FIG. 3 displays the separated pill compartments from the control unit. It can be seen that the pill compartments are removable and cascade-able. This structure makes this product convenient for people to use either at home or on travel.

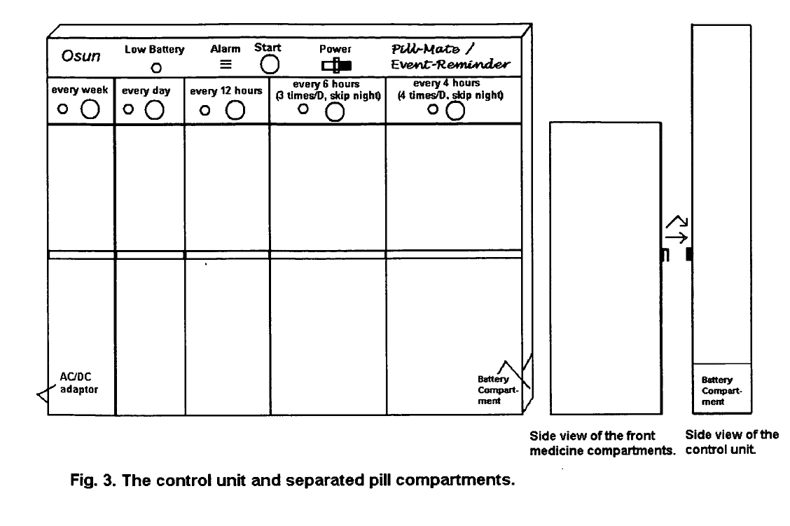

What is claimed is:

1. A pill-mate/event-reminder comprising: electronic reminder for 5 choices of pill taking or routine events. Users can choose 1-5 of the choices by pushing the corresponding switches:
4 times/day, every 4 hours, skip night; suggested time is 8 pm, 8 am, 12 pm, and 4 pm,
3 times/day, every 6 hours, skip night; suggested time is 8 pm, 8 am, and 2 pm,
2 times/day, every 12 hours, skip night; suggested time is 8 pm, and 8 pm,
1 time/day, every 24 hours; suggested time is 8 pm,
1 time/week; suggested time is 8 pm, Sunday,
Toggling the switch will result the said choice turned on and off alternatively.

2. A pill-mate/event-reminder according to claim 1, further comprising a start button to start all setup timing simultaneously. This arrangement can guarantee the synchronization of all said choices.

3. A pill-mate/event-reminder according to claim 1, further comprising a buzzer or other devices to provide audible signal for people to be aware of the timing for taking medicines. The alarm is shared by all said choices. People can turn the said choice off and re-set the timing by pushing the switch at the corresponding said choice. When the last said choice is turned off the alarm will go off.

4. A pill-mate/event-reminder according to claim 1, further comprising light-emitting diodes (LEDs) or other indicators to indicate the status of the alarm. The flashing said LED on the corresponding pre-set timing shows the time is due on that said choice. All said LEDs on the 5 said choices could be flashing at the same time depending on the user's settings.

5. A pill-mate/event-reminder according to claim 1, further comprising other options such as switches for power on/off indication. This switch has clear on/off indication by a color label, or a LED showing the on/off status.

6. A pill-mate/event-reminder according to claim 1, could have ribbons connected to the handles on the front side of the control unit and the medicine compartments to cascade many pill bottles to the corresponding said choice so users can embrace all pill bottles he/she needs to take. It is for use when people stay at home. For traveling, see next claim.

7. A pill-mate/event-reminder according to claim 1, further comprising medicine compartments which are assemble for travel convenience. People can pour their medicine into the compartments so they do not have to take all the pill bottles with them to save space in the luggage. Those medicine compartments are cascade-able, and people can choose the right amount of compartments for their individual needs. The medicine compartments have a secure lock to prevent accidental opening of the lids.

8. A pill-mate/event-reminder according to claim 1, has different medicine compartment sizes for general situation. For example, the medicine compartment corresponding to said choice of 4 times/day has bigger size than that of 1 time/day.

9. A pill-mate/event-reminder according to claim 1, further comprising low battery indication to warn people to replace battery.

10. A pill-mate/event-reminder according to claim 1, further comprising power failure battery backup function.

11. A pill-mate/event-reminder according to claim 1, further comprising AC/DC adaptor for people to use at home to save battery.

12. A pill-mate/event-reminder according to claim 1, can also be used for meetings and other routine events reminding.
